(19) United States
(12) Patent Application Publication
(10) Pub. No.: US 2013/0211718 A1
(43) Pub. Date: Aug. 15, 2013

(54) APPARATUS AND METHOD FOR PROVIDING INDOOR NAVIGATION SERVICE

(71) Applicants: Jae-Jun Yoo, Daejeon (KR); Su-Wook Ha, Daejeon (KR); So-Yeon Lee, Daejeon (KR); Kyong-Ho Kim, Daejeon (KR)

(72) Inventors: Jae-Jun Yoo, Daejeon (KR); Su-Wook Ha, Daejeon (KR); So-Yeon Lee, Daejeon (KR); Kyong-Ho Kim, Daejeon (KR)

(73) Assignee: ELECTRONICS AND TELECOMMUNICATIONS RESEARCH INSTITUTE, Daejeon-City (KR)

(21) Appl. No.: 13/570,950

(22) Filed: Aug. 9, 2012

(30) Foreign Application Priority Data
Feb. 9, 2012 (KR) 10-2012-0013245

(51) Int. Cl. G01C 21/00; G01C 21/10

(52) U.S. Cl. 701/500; 701/523

(57) ABSTRACT

Disclosed herein is an apparatus and method for providing an indoor navigation service. An apparatus includes a communication module for, when an indoor navigation service is executed, accessing a service server for providing the indoor navigation service. An image control module acquires indoor images in real time and displays the indoor images on an indoor navigation screen. An indoor location recognition module extracts indoor marker from the indoor images, obtains information about the extracted indoor marker, and recognizes a current location in the indoor space based on the indoor marker information. An indoor navigation module requests indoor navigation information to the service server based on information about the current location and destination information, and displays the indoor navigation information.

### CROSS REFERENCE TO RELATED APPLICATION

This application claims the benefit of Korean Patent Application No. 10-2012-0013245, filed on Feb. 9, 2012, which is hereby incorporated by reference in its entirety into this application.

### BACKGROUND OF THE INVENTION

1. Technical Field

The present invention relates generally to an apparatus and method for providing an indoor navigation service and, more particularly, to an apparatus and method that provide an indoor navigation service using location information obtained by recognizing markers attached to an indoor space via an image acquisition means such as a camera mounted in a user terminal.

2. Description of the Related Art

As the structure of an indoor space becomes more and more complicated as in the case of large-scale shopping malls and convention centers, and a large part of a life is now conducted indoors, the importance of services provided based on various types of indoor space information has increased. Accordingly, research into related technologies and the development of related systems have been actively promoted. Such research and development have been further promoted because the performance of mobile terminals such as smart phones becomes higher and mobile terminals are connected online to external systems.

Indoor navigation services are intended to accurately detect the location of a mobile terminal and transfer route information complying with a user's request based on the location of the user.

Mobile terminal location detection methods that have been investigated and developed for indoor navigation services are mainly intended to detect locations either using the locations of Access Points (APs) used in a Wireless Local Area Network (WLAN), sensitivity to the reception of signals from the APs, etc., or using sensor nodes installed indoors and Radio Frequency Identification (RFID) tags (passive/active tags). An embodiment of this technology is disclosed in U.S. Patent Application No. US2009-399041.

However, this technology is disadvantageous in that the estimation of locations of users and mobile terminals may be performed at relatively low accuracy depending on the circumstances. For example, when only the method of measuring the APs of a WLAN is used, a location error of about several tens of meters may occur depending on the circumstances and it may be difficult to detect the location of an accurate floor. Further, the method of measuring the APs of a WLAN requires a lot of equipment for obtaining location information, and also requires a lot of installation and management costs.

### SUMMARY OF THE INVENTION

Accordingly, the present invention has been made keeping in mind the above problems occurring in the prior art, and an object of the present invention is to provide an apparatus and method for providing an indoor navigation service, which recognize markers attached indoors using an image acquisition means such as a camera mounted in a user terminal, and provide the indoor navigation service using location information obtained through the markers.

In accordance with an aspect of the present invention to accomplish the above object, there is provided an apparatus for providing an indoor navigation service, including a communication module for, when an indoor navigation service for guiding a current location and a movement route in an indoor space in which a user is located is executed, accessing a service server for providing the indoor navigation service via communication, an image control module for acquiring indoor images in real time using image acquisition means and displaying the indoor images on an indoor navigation screen while the indoor navigation service is being executed, an indoor location recognition module for extracting at least one indoor marker from the indoor images acquired in real time by the image acquisition means, obtaining information about the extracted indoor marker, and recognizing a current location in the corresponding indoor space based on the indoor marker information, and an indoor navigation module for requesting indoor navigation information to the service server based on information about the current location in the corresponding indoor space, recognized by the indoor location recognition module, and destination information, requested by the user, and displaying the indoor navigation information provided by the service server on the indoor navigation screen.

Preferably, the indoor location recognition module may be provided with registered information about indoor markers, arranged in the corresponding indoor space, by the service server when the indoor navigation service is executed.

Preferably, the registered information about the indoor markers may include at least one of a marker identification (ID), a size, an installation direction, latitude, longitude, an installation address, a marker type, and other update information of each marker.

Preferably, the indoor location recognition module may extract information about the indoor marker, included in the indoor images acquired in real time by the image acquisition means, from the registered information about the indoor markers provided by the service server.

Preferably, the apparatus may further include a sensor management module for controlling at least one sensor provided in the apparatus for providing the indoor navigation service.

Preferably, the sensor management module may obtain sensor measurement values by controlling at least one of a gyro sensor, a direction sensor, and an acceleration sensor.

Preferably, the indoor location recognition module may determine the current location in the corresponding indoor space, based on the information about the indoor marker included in the indoor images acquired in real time by the image acquisition means and sensor measurement values measured by the at least one sensor controlled by the sensor management module.

Preferably, the indoor navigation module may display the indoor navigation information provided by the service server on a split screen of the indoor navigation screen.

Preferably, the indoor navigation module may display the indoor navigation information provided by the service server to be superimposed on the indoor images displayed in real time on the indoor navigation screen.

In accordance with another aspect of the present invention to accomplish the above object, there is provided a method of providing an indoor navigation service, including when an indoor navigation service for guiding a current location and a movement route in an indoor space in which a user is located is executed, accessing a service server for providing the indoor navigation service via communication, acquiring indoor images in real time using image acquisition means and displaying the indoor images on an indoor navigation screen while the indoor navigation service is being executed, extracting at least one indoor marker from the indoor images acquired in real time by the image acquisition means, obtaining information about the extracted indoor marker, and recognizing a current location in the corresponding indoor space based on the indoor marker information, requesting indoor navigation information to the service server based on information about the current location in the corresponding indoor space, recognized at the recognizing the current location, and destination information, requested by the user, and displaying the indoor navigation information provided by the service server on the indoor navigation screen.

Preferably, the method may further include being provided with registered information about indoor markers, arranged in the corresponding indoor space, by the service server when the indoor navigation service is executed.

Preferably, the registered information about the indoor markers may include at least one of a marker identification (ID), a size, an installation direction, latitude, longitude, an installation address, a marker type, and other update information of each marker.

Preferably, the recognizing the current location may include extracting information about the indoor marker, included in the indoor images acquired in real time by the image acquisition means, from the registered information about the indoor markers provided by the service server.

Preferably, the method may further include obtaining sensor measurement values by controlling at least one sensor when the indoor navigation service is executed.

Preferably, the sensor may include at least one of a gyro sensor, a direction sensor, and an acceleration sensor.

Preferably, the recognizing the current location may be configured to determine the current location in the corresponding indoor space, based on the information about the indoor marker included in the indoor images acquired in real time by the image acquisition means and sensor measurement values obtained at the obtaining the sensor measurement values.

Preferably, the displaying on the indoor navigation screen may include displaying the indoor navigation information provided by the service server on a slit screen of the indoor navigation screen.

Preferably, the displaying on the indoor navigation screen may include displaying the indoor navigation information provided by the service server to be superimposed on the indoor images displayed in real time on the indoor navigation screen.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing the configuration of an indoor navigation system according to an embodiment of the present invention;

FIG. 2 is a block diagram showing the configuration of an apparatus for providing an indoor navigation service according to the present invention;

FIG. 3 is a block diagram showing the detailed configuration of the image acquisition module of the indoor navigation service provision apparatus according to the present invention;

FIG. 4 is a block diagram showing the detailed configuration of the indoor location recognition module of the indoor navigation service provision apparatus according to the present invention;

FIG. 5 is a block diagram showing the detailed configuration of the indoor navigation module of the indoor navigation service provision apparatus according to the present invention;

FIG. 6 is a block diagram showing the detailed configuration of the sensor management module of the indoor navigation service provision apparatus according to the present invention;

FIG. 7 is a block diagram showing the configuration of the service server of the indoor navigation system according to the present invention;

FIG. 8 is a block diagram showing the configuration of the indoor space information DB of the indoor navigation system according to the present invention;

FIG. 9 is a diagram illustrating a first embodiment of an indoor marker applied to the present invention;

FIG. 10 is a diagram showing an example of registered information about an indoor marker;

FIG. 11 is a diagram illustrating a second embodiment of an indoor marker applied to the present invention;

FIG. 12 is a diagram illustrating the indoor marker recognition operation of the indoor navigation service provision apparatus according to the present invention;

FIG. 13 is a diagram illustrating the operation of the indoor navigation service provision apparatus according to the present invention; and

FIG. 14 is a flowchart showing the operation flow of a method of providing an indoor navigation service according to the present invention.

### DESCRIPTION OF THE PREFERRED EMBODIMENTS

Hereinafter, embodiments of the present invention will be described in detail with reference to the attached drawings.

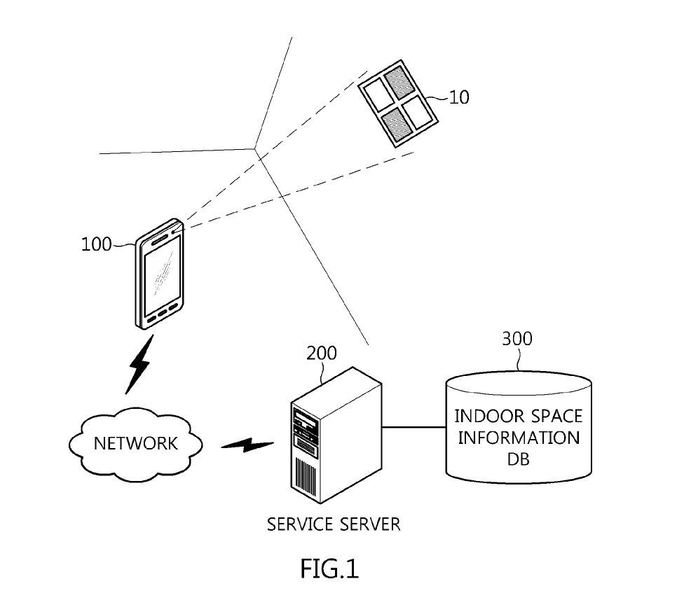

FIG. 1 is a diagram showing the configuration of an indoor navigation system according to the present invention.

As shown in FIG. 1, the indoor navigation system according to the present invention is configured such that a plurality of indoor markers 10 are attached to an indoor space, and an apparatus 100 for providing an indoor navigation service (hereinafter referred to as a “service provision apparatus”) recognizes the indoor markers 10 attached to the indoor space.

Here, the indoor markers 10 installed in the indoor space for indoor navigation are means for displaying information about a specific location in the indoor space, and have a shape that can be easily recognized and extracted from images of the corresponding indoor markers 10. Further, the indoor markers 10 may be installed on a ceiling, walls, a floor, etc., and information about the indoor markers 10 must be suitably configured depending on the installation locations thereof.

The service provision apparatus 100 can recognize the indoor markers 10 by capturing the corresponding indoor markers 10 using an image acquisition means such as a camera. The service provision apparatus 100 requests indoor information from a service server 200 based on the information recognized through the indoor markers 10.

The service server 200 stores information about the indoor markers 10 installed indoors and the indoor space in an indoor space information database (DB) 300, and maintains and manages the pieces of stored information. In this case, the service server 200 searches the indoor space information DB 300 for a requested route based on the information about the indoor markers 10 transmitted from the service provision apparatus 100, and provides navigation information at a corresponding location to the service provision apparatus 100 based on the results of the search.

Therefore, the service provision apparatus 100 outputs navigation information from the service server 200 in images, text, voice, or the like, thus providing the indoor navigation service to users.

The service provision apparatus 100 applied to the present invention is a user terminal, such as a mobile phone or a tablet Personal Computer (PC), provided with an image acquisition means for recognizing markers and a communication interface enabling transmission and reception to and from the service server 200.

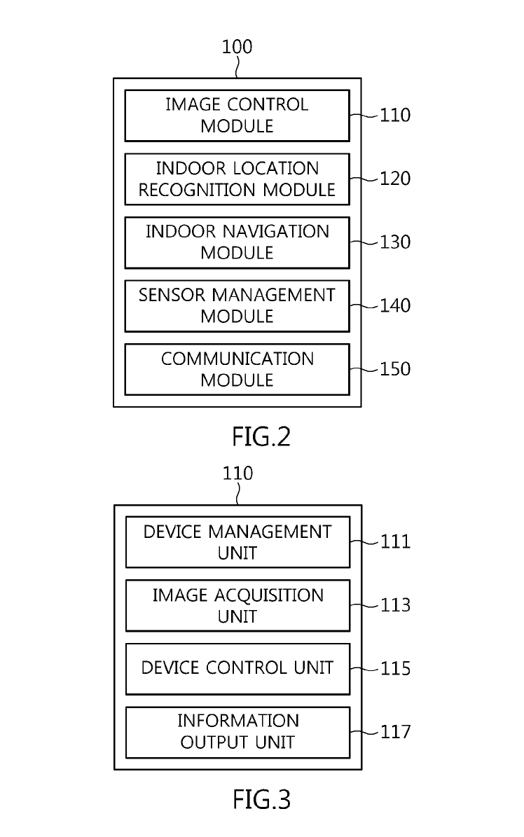

FIG. 2 is a block diagram showing the configuration of the apparatus for providing an indoor navigation service according to the present invention.

As shown in FIG. 2, the service provision apparatus 100 according to the present invention includes an image control module 110, an indoor location recognition module 120, an indoor navigation module 130, a sensor management module 140, and a communication module 150.

The image control module 110 acquires indoor marker images by capturing indoor markers via the control of an image acquisition means such as a camera, and performs control such that navigation information provided by a service server based on the indoor marker images captured by the image acquisition means is output via a video output means or an audio output means. A description of the detailed construction of the image control module 110 will be described later in detail with reference to FIG. 3.

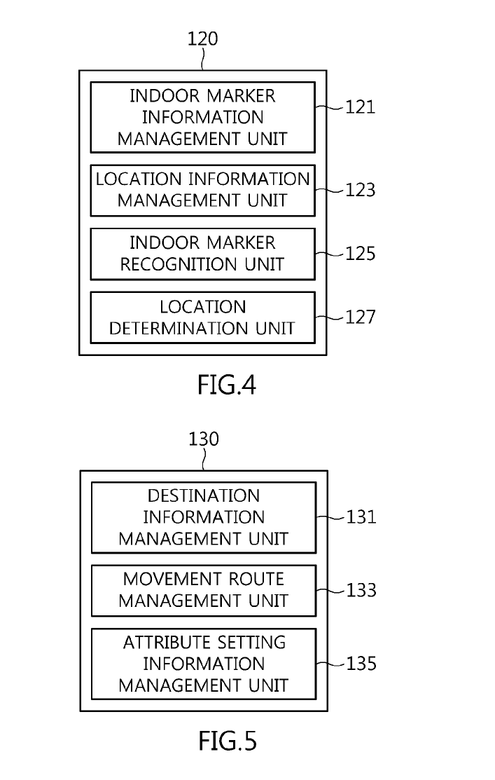

The indoor location recognition module 120 extracts indoor markers from the acquired indoor marker images, and recognizes information about the indoor markers from the corresponding indoor markers. In this case, the indoor location recognition module 120 determines the location of the service provision apparatus 100 based on information about the indoor markers, previous location information, and sensor information obtained by sensors, such as a gyro sensor, a direction sensor, and an acceleration sensor. The detailed configuration of the indoor location recognition module 120 will be described later with reference to FIG. 4.

The indoor navigation module 130 performs indoor navigation based on indoor locations. In this case, the indoor navigation module 130 provides navigation information provided by the service server based on the location information recognized by the indoor location recognition module 120. The indoor navigation module 130 may provide various functions according to the type of navigation-related information desired by the user to be obtained. The detailed configuration of the indoor navigation module 130 will be described later with reference to FIG. 5.

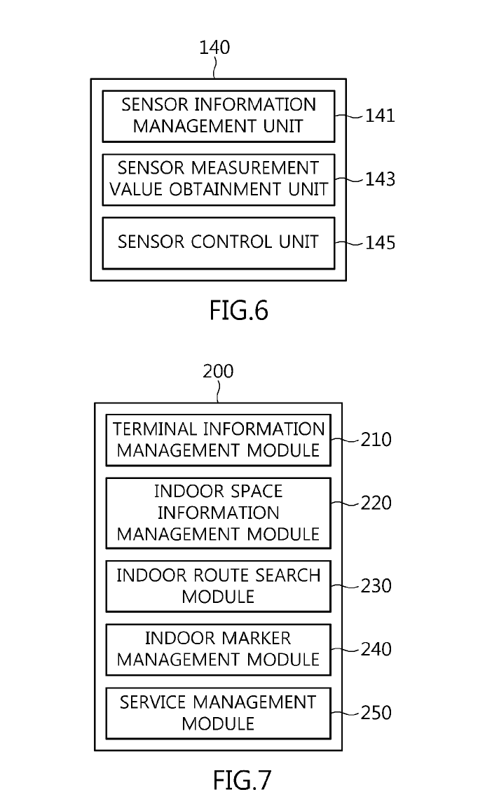

The sensor management module 140 manages sensors provided in the service provision apparatus 100, for example, a gyro sensor, a direction sensor, an acceleration sensor, etc., and controls the functions of the respective sensors. The detailed configuration of the sensor management module 140 will be described later with reference to FIG. 6.

The communication module 150 provides a communication interface for communicating with the service server so as to provide the indoor navigation service. In this case, the communication module 150 may include a communication protocol required to communicate with the indoor navigation service server using Code Division Multiple Access (CDMA), a Wireless Local Area Network (WLAN), or the like, and a communication protocol processing module for analyzing protocol packets received from the service server and generating protocol packets.

FIG. 3 is a block diagram showing the detailed configuration of the image control module of FIG. 2.

As shown in FIG. 3, the image control module 110 includes a device management unit 111, an image acquisition unit 113, a device control unit 115, and an information output unit 117.

The device management unit 111 registers and manages information about the image acquisition means, such as the device information and the focal length of the image acquisition means.

The image acquisition unit 113 acquires images in real time from the image acquisition means registered in the device management unit 111.

The device control unit 115 controls the corresponding image acquisition means so as to acquire images from the image acquisition means. As an example, the device control unit 115 controls functions, such as the zoom-in and zoom-out functions of the image acquisition means.

The information output unit 117 outputs the indoor navigation information provided by the service server in real time. In this case, the indoor navigation information may be output in the form of at least one of a video, an image, text, and voice. Further, the information output unit 117 may output navigation-related information in real time over the images acquired by the image acquisition means.

FIG. 4 is a block diagram showing the detailed configuration of the indoor location recognition module of FIG. 2.

As shown in FIG. 4, the indoor location recognition module according to the present invention includes an indoor marker information management unit 121, a location information management unit 123, an indoor marker recognition unit 125, and a location determination unit 127.

The indoor marker information management unit 121 manages information about indoor markers installed in a target indoor space. For example, the indoor marker information management unit 121 manages identification information about the individual markers arranged in the indoor space, information about locations at which the markers are arranged, etc.

Here, the indoor marker information management unit 121 may request information about the indoor markers arranged in the indoor space from the service server, and may store and manage the information about the indoor markers provided by the service server. As another example, the indoor marker information management unit 121 may be provided with information about the corresponding indoor markers in real time via interworking with the service server without separately storing the information about the indoor markers arranged in the indoor space.

The location information management unit 123 manages pieces of previous location information which were recognized indoors. In other words, the location information management unit 123 manages route information, surrounding location information, surrounding shopping center information, etc. which were previously recognized through the indoor markers.

The indoor marker recognition unit 125 analyzes the images acquired by the image acquisition means, and then recognizes indoor markers that are located around the service provision apparatus and are included in the corresponding images.

The location determination unit 127 is configured to, if images for location determination have been acquired by the image acquisition means, combine the pieces of information from the indoor marker information management unit 121, the location information management unit 123, and the indoor marker recognition unit 125, and then determine the current location of the service provision apparatus, that is, the user terminal.

As an example, the location determination unit 127 combines indoor marker information which is recognized from the images acquired by the image acquisition means, information about locations at which the corresponding indoor markers are arranged, and location information which was previously recognized in the corresponding indoor space, and then determines the current location of the service provision apparatus.

FIG. 5 is a block diagram showing the detailed configuration of the indoor navigation module of FIG. 2.

As shown in FIG. 5, the indoor navigation module 130 according to the present invention includes a destination information management unit 131, a movement route management unit 133, and an attribute setting information management unit 135.

The destination information management unit 131 manages destination information entered by a user for an indoor navigation service.

The movement route management unit 133 manages a previous movement route from a location corresponding to a time point, at which the indoor navigation service was first provided, to a current location, on the basis of the location information recognized by the indoor location recognition module 120.

Further, the movement route management unit 133 manages the overall route to the destination entered by the user, a predicted route for movement from the current location to the destination, etc. depending on the navigation information provided by the service server based on the location information recognized by the indoor location recognition module.

The attribute setting information management unit 135 manages user preference-related attribute setting information associated with indoor navigation. For example, the attribute setting information management unit 135 may set whether to provide information about the guidance of a distance to the destination or an estimated arrival time for the destination, the preliminary guidance of a direction change, emergency guidance, the guidance of surrounding shopping center information, etc. to the user.

Therefore, the indoor navigation module 130 provides the indoor navigation service based on the pieces of information from the destination information management unit 131, the movement route management unit 133, and the attribute setting information management unit 135.

FIG. 6 is a block diagram showing the detailed configuration of the sensor management module of FIG. 2.

As shown in FIG. 6, the sensor management module 140 according to the present invention includes a sensor information management unit 141, a sensor measurement value obtainment unit 143, and a sensor control unit 140.

The sensor information management unit 141 registers and manages information about a plurality of sensors provided in the service provision apparatus, that is, the user terminal, for example, a gyro sensor, a direction sensor, an acceleration sensor, etc.

The sensor measurement value obtainment unit 143 obtains measurement values measured by the sensors registered on the sensor information management unit 141 under the control of the sensor control unit 145.

The sensor control unit 145 controls the sensors registered on the sensor information management unit 141 and manages the measurement values obtained by the sensor measurement value obtainment unit 143.

FIG. 7 is a block diagram showing the configuration of the service server of the indoor navigation system according to the present invention.

As shown in FIG. 7, the service server 200 according to the present invention includes a terminal information management module 210, an indoor space information management module 220, an indoor route search module 230, an indoor marker management module 240, and a service management module 250.

The terminal information management module 210 stores and manages information about the service provision apparatus, that is, the user terminal, which accesses the service server 200.

The indoor space information management module 220 stores indoor space-related information and data that must be provided in relation to the indoor navigation service in the indoor space information DB, and maintains and manages the information and data stored in the indoor space information DB. As an example, the indoor space information management module 220 manages indoor space models, indoor Point of Interest (POI), indoor models, etc.

The indoor route search module 230 searches the corresponding indoor space for a movement route using the current location and destination information of the service provision apparatus that requested the indoor navigation service.

The indoor marker management module 240 maintains and manages information about the indoor markers installed in the corresponding indoor space. Here, the information about the indoor markers is stored in the indoor space information DB. The indoor marker management module 240 may provide information about markers arranged in a specific indoor space to a relevant service provision apparatus in response to a request from the service provision apparatus.

The service management module 250 manages the status of the operation of the indoor navigation service. As an example, when a request for the indoor navigation service is received from the service provision apparatus, the service management module 250 configures indoor navigation information requested by the service provision apparatus by driving the terminal information management module 210, the indoor space information management module 220, the indoor route search module 230, and the indoor marker management module 240, and provides completed indoor navigation information to the service provision apparatus in real time.

Further, the service management module 250 may also provide information obtained by driving related modules to a relevant service provision apparatus when a request for specific information is received from the service provision apparatus.

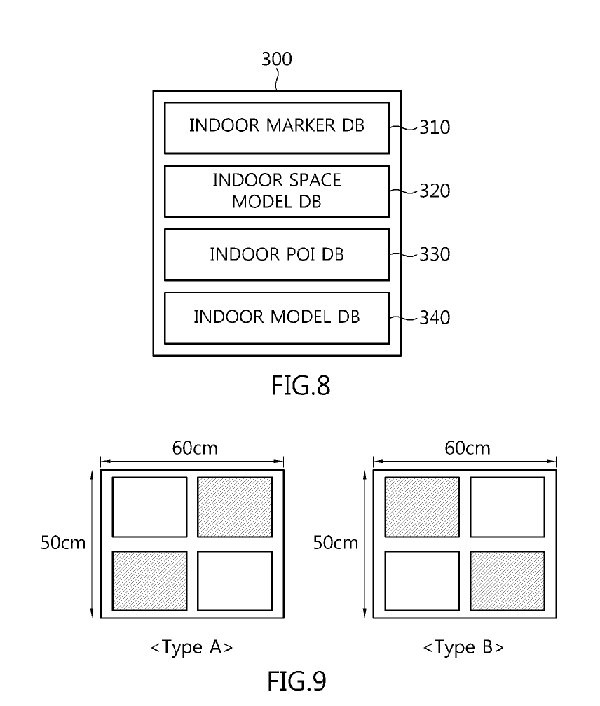

FIG. 8 is a block diagram showing the configuration of the indoor space information DB of the indoor navigation system according to the present invention.

The indoor space information DB 300 stores the indoor space information and pieces of related data of the indoor navigation system using indoor markers. In this case, the indoor space information DB 300 calls and provides information or data requested by the service server from the indoor space information and the related data that are stored therein.

As shown in FIG. 8. the indoor space information DB 300 includes an indoor marker DB 310, an indoor space model DB 320, an indoor POI DB 330, and an indoor model DB 340.

The indoor marker DB 310 stores information about indoor markers installed in the indoor space. As an example, the indoor marker DB 310 stores identification information required to identify the indoor markers, size information, type information, validity information, and location information such as the address, latitude/longitude, and direction of a location at which each indoor marker is arranged.

The indoor space model DB 320 stores modeling information about the indoor space, for example, node or link information related to a possible route or the like.

The indoor POI DB 330 stores indoor Point of Interest (POI) information including information about stores or the like located within the indoor space.

The indoor model DB 340 stores the geographic models of structures such as the wall, ceiling, floor, gate, and pillar of the indoor space.

FIG. 9 is a diagram illustrating a first embodiment of an indoor marker applied to the present invention.

Indoor markers may be implemented in various shapes depending on an indoor environment, a purpose, etc., and may be formed in a simple shape, as shown in FIG. 9.

In other words, in FIG. 9, a marker is configured such that four rectangles are arranged therein and the colors thereof are set to different colors, so that the marker can be distinguished from other markers.

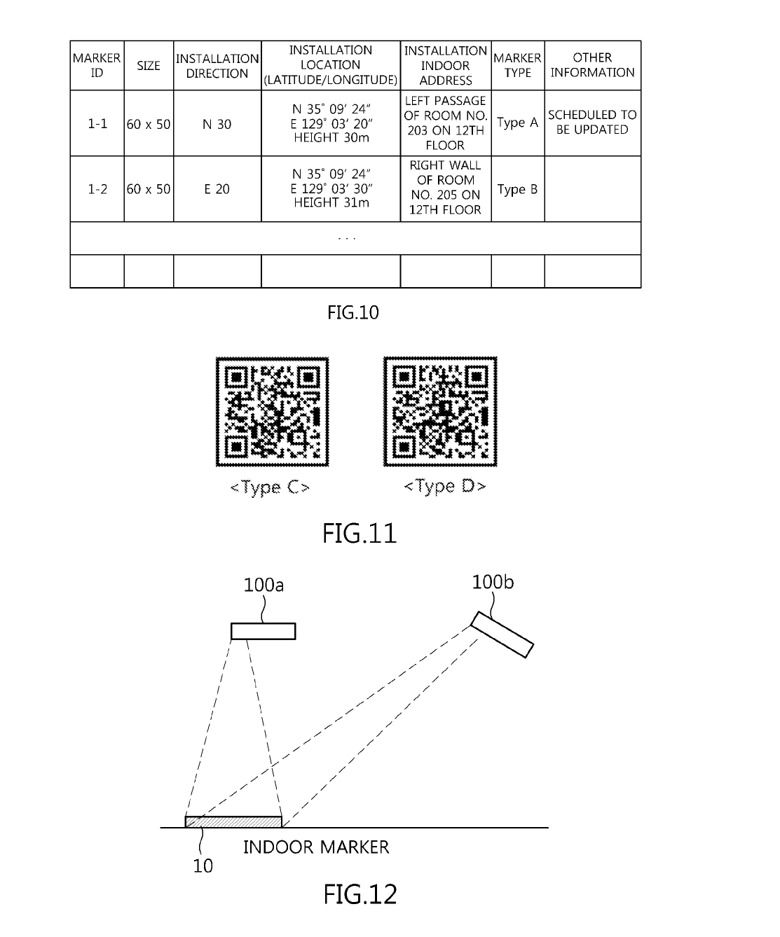

When it is difficult to obtain various types of information using indoor markers having a simple shape, as shown in FIG. 9, information about relevant indoor markers is registered on the service server, and the information about the indoor markers can be obtained based on the registered information. An example of registered information about an indoor marker is shown in FIG. 10.

As shown in FIG. 10, registered information about the indoor maker may correspond to marker identification (ID), size, installation direction, installation location (latitude/longitude), installation indoor address, marker type, and other information of the indoor marker.

For example, an indoor marker having a marker ID of ‘1-1’ can be registered as having a size of ‘60×50’, an installation direction of ‘N30’, an installation location of ‘N35° 09′24″ E129° 03′20″ and a height of 30 m’, an installation indoor address of ‘left passage of room No. 203 on the 12th floor’, a marker type of ‘type A’, etc. Further, an indoor marker having a marker ID of ‘1-2’ can be registered as having a size of ‘60×50’, an installation direction of ‘E20’, an installation location of ‘N35° 09′24″ E129° 03′30″ and a height of 31 m’, an installation indoor address of ‘right wall of room No. 205 on the 12th floor’, a marker type of ‘type B’, etc.

Of course, it is apparent that in addition to the pieces of information shown in FIG. 10, any type of information can be freely added as long as it enables the location of the service provision apparatus to be estimated using indoor markers recognized from the images acquired by the service provision apparatus.

FIG. 11 is a diagram illustrating a second embodiment of an indoor marker applied to the present invention. In FIG. 11, an example of an indoor marker capable of including therein various types of information, rather than the simple shape shown in FIG. 9, is depicted.

As shown in FIG. 11, an indoor marker can be implemented as a Quick Response (QR) code. The QR code is a grid-shaped two-dimensional (2D) code, which can contain more information than that of a barcode and has high recognition speed and rate. Such a QR code has been utilized in various fields as smart phones have recently been widely popularized.

In this way, when the location information of a relevant indoor space is inserted into a QR code, a service provision terminal recognizes the QR code and is then capable of easily obtaining pieces of information inserted into the QR code.

Of course, it is apparent that a type of indoor marker newly designed to suit an indoor environment can be used in addition to the QR code. In this case, the service provision apparatus assumes that a program for recognizing various types of indoor markers was installed in advance.

FIG. 12 is a diagram illustrating the indoor marker recognition operation of the indoor navigation service provision apparatus according to the present invention.

As shown in FIG. 12, in order to measure the current location of the service provision apparatus for the indoor navigation service, the current location is estimated by recognizing an indoor marker 10 arranged in an indoor space. In this case, the service provision apparatus can recognize the indoor marker 10 from images captured by the image acquisition means, and may also recognize the indoor marker 10 by executing a separate program in some cases.

Meanwhile, in order to use the indoor navigation service, the user of the service provision apparatus must capture the indoor marker 10 attached to the indoor space, so that the indoor marker 10 is arranged at a location that can be easily found by the user.

For example, when the user searches the indoor space for a route using his or her service provision apparatus, that is, a user terminal, there are many cases when the user vertically or obliquely views the floor rather than looking at a movement route. Accordingly, the indoor marker 10 is preferably arranged on a floor surface or around the floor surface so that the user can easily recognize the indoor marker 10.

As shown in FIG. 12, when a first service provision apparatus 100a is located in parallel with the floor surface, the indoor marker 10 is installed on the floor surface and can then be easily recognized. Of course, even when a second service provision apparatus 100b is located to be oblique with respect to the floor surface, the indoor marker 10 is installed on the floor surface and can then be easily recognized. This is only a preferable embodiment, and the location at which the indoor marker 10 is arranged can be reconstructed in accordance with the characteristics or the like of the corresponding indoor space.

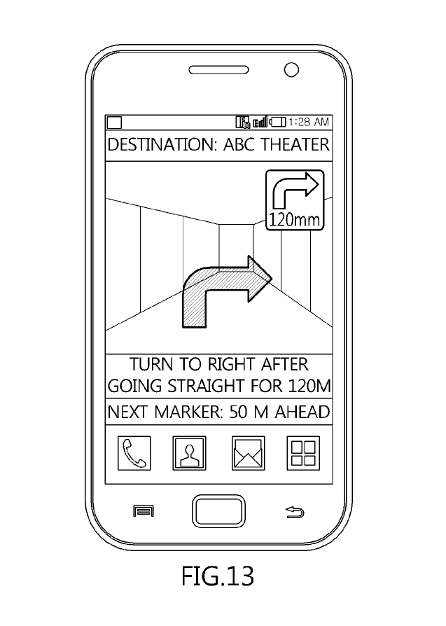

FIG. 13 is a diagram illustrating the operation of the indoor navigation service provision apparatus according to the present invention, which shows an indoor navigation screen.

When the service provision apparatus requests an indoor navigation service from the service server based on indoor location information obtained by recognizing indoor markers arranged in the indoor space, indoor navigation information provided by the service server is displayed on a screen, as shown in FIG. 13, so that the user can check the indoor navigation information.

As shown in 13, destination information entered by the user and an image acquired in real time by the image acquisition means at a current location are displayed on the indoor navigation screen of the service provision apparatus. In this case, the indoor navigation information provided by the service server may be displayed to be superimposed on the image acquired by the image acquisition means in real time, or displayed on another split screen.

For example, direction information such as “turn to the right after going straight for 120 m” and information indicating the location of a subsequent marker may be displayed on split screens in a lower portion of the screen, and a movement direction arrow may be displayed to be superimposed on the image acquired in real time.

Although not shown in FIG. 13, the service provision apparatus may display sensor measurement values that have been measured by sensor modules together on the indoor navigation screen depending on the settings.

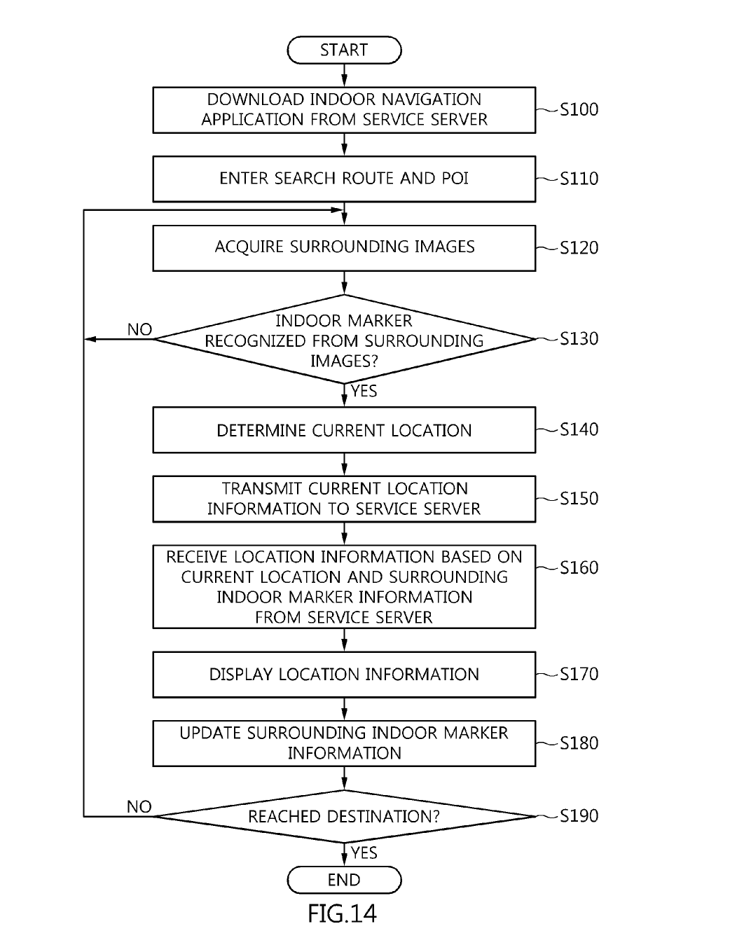

FIG. 14 is a flowchart showing the operation flow of a method of providing an indoor navigation service according to the present invention.

As shown in FIG. 14, the service provision apparatus according to the present invention downloads an indoor navigation application from the service server so as to provide an indoor navigation service at step S100. In this case, the service provision apparatus accesses the service server by executing the indoor navigation application downloaded at step S100, and enters a search route, a POI, etc. for indoor navigation at step S110.

Thereafter, the service provision apparatus acquires surrounding images in real time via an image acquisition means so as to obtain current location information based on the movement of the location thereof at step S120, and recognizes indoor markers from the surrounding images that are acquired in real time at step S130, and then determines the current location of the service provision apparatus at step S140.

Here, the service provision apparatus determines the current location thereof using information about indoor markers (for example, the locations, directions, etc. of installation of the indoor markers) recognized from the acquired real-time images, the setting information of the image acquisition means (for example, a focal length, resolution, etc.), previous location information, and information measured by sensors provided in the service provision apparatus (for example, a gyro sensor, a direction sensor, an acceleration sensor, etc.).

In this case, the service provision apparatus requests the indoor navigation service from the service server by transmitting the current location information to the service server at step S150.

The service server transmits indoor navigation information, which includes location information, such as a movement direction and distance, and surrounding indoor marker information, to the service provision apparatus on the basis of the current location information provided by the service provision apparatus and the information of the corresponding service provision apparatus.

When the indoor navigation information including the location information of the movement route based on the current location and the surrounding indoor marker information is received from the service server at step S160, the service provision apparatus displays the location information included in the indoor navigation information on the indoor navigation screen at step S170, and updates surrounding indoor marker information depending on the movement of the location at step S180.

When the indoor markers include various types of information required for location recognition, such as a QR code, the service provision apparatus may not separately receive surrounding indoor marker information from the service server at step S160.

The service provision apparatus repetitively performs the procedure from step S120 to step S180 until it reaches the destination entered by the user, and terminates the related operations when it reaches the destination at step S190.

The indoor navigation service described in the present invention has a scheme for allowing the external server of the service provision apparatus, that is, the service server, to perform a route search or the like for indoor navigation, as the gist of the invention. However, when the indoor space is relatively narrow, and security for indoor space information is provided, the service provision apparatus may download all information for the indoor navigation service from the service server, and then provide the indoor navigation service without performing communication with external systems.

According to the present invention, there is an advantage in that markers attached to an indoor space are recognized using an image acquisition means such as a camera or the like mounted in a user terminal, and an indoor navigation service is provided using location information obtained through the markers, thus providing a high-precision service at low costs.

Further, the present invention is advantageous in that the indoor navigation service is provided using images acquired in real time by an image acquisition means, so that a more realistic service than an existing service provided in the form of simple text and figures can be provided.

As described above, although the apparatus and method for providing an indoor navigation service according to the present invention have been described with reference to the illustrated drawings, they are only embodiments of indoor navigation using indoor markers and a user terminal capable of acquiring images. The present invention is not limited by the embodiments and the drawings disclosed in the present specification, and can be modified and changed without departing from the scope and spirit of the invention.

What is claimed is:

1. An apparatus for providing an indoor navigation service, comprising:
a communication module for, when an indoor navigation service for guiding a current location and a movement route in an indoor space in which a user is located is executed, accessing a service server for providing the indoor navigation service via communication;
an image control module for acquiring indoor images in real time using image acquisition means and displaying the indoor images on an indoor navigation screen while the indoor navigation service is being executed;
an indoor location recognition module for extracting at least one indoor marker from the indoor images acquired in real time by the image acquisition means, obtaining information about the extracted indoor marker, and recognizing a current location in the corresponding indoor space based on the indoor marker information; and
an indoor navigation module for requesting indoor navigation information to the service server based on information about the current location in the corresponding indoor space, recognized by the indoor location recognition module, and destination information, requested by the user, and displaying the indoor navigation information provided by the service server on the indoor navigation screen.

2. The apparatus of claim 1, wherein the indoor location recognition module is provided with registered information about indoor markers, arranged in the corresponding indoor space, by the service server when the indoor navigation service is executed.

3. The apparatus of claim 2, wherein the registered information about the indoor markers comprises at least one of a marker identification (ID), a size, an installation direction, latitude, longitude, an installation address, a marker type, and other update information of each marker.

4. The apparatus of claim 2, wherein the indoor location recognition module extracts information about the indoor marker, included in the indoor images acquired in real time by the image acquisition means, from the registered information about the indoor markers provided by the service server.

5. The apparatus of claim 1, further comprising a sensor management module for controlling at least one sensor provided in the apparatus for providing the indoor navigation service.

6. The apparatus of claim 5, wherein the sensor management module obtains sensor measurement values by controlling at least one of a gyro sensor, a direction sensor, and an acceleration sensor.

7. The apparatus of claim 5, wherein the indoor location recognition module determines the current location in the corresponding indoor space, based on the information about the indoor marker included in the indoor images acquired in real time by the image acquisition means and sensor measurement values measured by the at least one sensor controlled by the sensor management module.

8. The apparatus of claim 1, wherein the indoor navigation module displays the indoor navigation information provided by the service server on a split screen of the indoor navigation screen.

9. The apparatus of claim 1, wherein the indoor navigation module displays the indoor navigation information provided by the service server to be superimposed on the indoor images displayed in real time on the indoor navigation screen.

10. A method of providing an indoor navigation service, comprising:
when an indoor navigation service for guiding a current location and a movement route in an indoor space in which a user is located is executed, accessing a service server for providing the indoor navigation service via communication;
acquiring indoor images in real time using image acquisition means and displaying the indoor images on an indoor navigation screen while the indoor navigation service is being executed;
extracting at least one indoor marker from the indoor images acquired in real time by the image acquisition means, obtaining information about the extracted indoor marker, and recognizing a current location in the corresponding indoor space based on the indoor marker information;
requesting indoor navigation information to the service server based on information about the current location in the corresponding indoor space, recognized at the recognizing the current location, and destination information, requested by the user; and
displaying the indoor navigation information provided by the service server on the indoor navigation screen.

11. The method of claim 10, further comprising being provided with registered information about indoor markers, arranged in the corresponding indoor space, by the service server when the indoor navigation service is executed.

12. The method of claim 11, wherein the registered information about the indoor markers comprises at least one of a marker identification (ID), a size, an installation direction, latitude, longitude, an installation address, a marker type, and other update information of each marker.

13. The method of claim 11, wherein the recognizing the current location comprises extracting information about the indoor marker, included in the indoor images acquired in real time by the image acquisition means, from the registered information about the indoor markers provided by the service server.

14. The method of 10, further comprising obtaining sensor measurement values by controlling at least one sensor when the indoor navigation service is executed.

15. The method of claim 14, wherein the sensor comprises at least one of a gyro sensor, a direction sensor, and an acceleration sensor.

16. The method of claim 14, wherein the recognizing the current location is configured to determine the current location in the corresponding indoor space, based on the information about the indoor marker included in the indoor images acquired in real time by the image acquisition means and sensor measurement values obtained at the obtaining the sensor measurement values.

17. The method of claim 10, wherein the displaying on the indoor navigation screen comprises displaying the indoor navigation information provided by the service server on a slit screen of the indoor navigation screen.

18. The method of claim 10, wherein the displaying on the indoor navigation screen comprises displaying the indoor navigation information provided by the service server to be superimposed on the indoor images displayed in real time on the indoor navigation screen.
